(19) United States
(12) Patent Application Publication
(10) Pub. No.: US 2002/0104611 A1
(43) Pub. Date: Aug. 8, 2002

(54) Self-flattening screens for vibratory separators

(76) Inventors: Thomas C. Adams, Hockley, TX (US); Kerry T. Ward, Cypress, TX (US); Kenneth W. Seyffert, Houston, TX (US); David W. Largent, Cleveland, TX (US); David L. Schulte JR., Broussard, LA (US); Charles N. Grichar, Houston, TX (US); Vincent D. Leone, Houston, TX (US); Jefrey E. Walker, Lafayette, LA (US); Guy L. McClung III, Spring, TX (US)

Correspondence Address: PMB 347, 16690 Champion Forest Drive, Spring, TX, 77379-7023, US

(21) Appl. No.: 10/050,690

(22) Filed: Jan. 16, 2002

Related U.S. Application Data
(63) Continuation-in-part of application No. 10/037,474, filed on Oct. 19, 2001.
Application No. 10/037,474 is a continuation-in-part of application No. 09/603,531, filed on Jun. 27, 2000.
Application No. 09/603,531 is a continuation-in-part of application No. 09/517,212, filed on Mar. 2, 2000.
Application No. 09/517,212 is a continuation-in-part of application No. 09/454,722, filed on Dec. 4, 1999, now abandoned.
Application No. 09/454,722 is a continuation-in-part of application No. 09/390,231, filed on Sep. 3, 1999, now Pat. No. 6,325,216.
Application No. 09/454,722 is a continuation-in-part of application No. 09/707,277, filed on Nov. 6, 2000.
Application No. 09/707,277 is a continuation-in-part of application No. 09/183,004, filed on Oct. 30, 1998, now Pat. No. 6,186,337.

(51) Int. Cl. C09J 1/00; B32B 31/00

(52) U.S. Cl. 156/229; 209/300; 209/399; 209/403; 210/488; 156/160; 156/161

(57) ABSTRACT

A method for flattening non-flat areas of screening material of a screen assembly, the non-flat areas of screening material between lines of glue gluing together a plurality of layers of screening material, the plurality of glued-together layers of screening material secured to a frame, the method including mounting the screen assembly on a vibratory separator, the vibratory separator located in an environment at an ambient temperature, vibrating the screen assembly with the vibratory separator for a period of time, feeding material to be treated onto the screen assembly, the material to be treated at a material temperature above the ambient temperature, the period of time of such a temporal length and the material temperature of such a temperature to effect flattening of the non-flat areas of screening material.

### RELATED APPLICATIONS

This application is a continuation-in-part of U.S. application Ser. No. 10/037,474 filed Oct. 19, 2001, which is a continuation-in-part of U.S. application Ser. No. 09/603,531 filed Jun. 27, 2000 which is a continuation-in-part of U.S. application Ser. No. 09/517,212 filed Mar. 2, 2000 which is a continuation-in-part of U.S. application Ser. No. 09/454,722 filed on Dec. 4, 1999 which is a continuation-in-part of U.S. application Ser. No. 09/390,231 filed Sep. 3, 1999; and this application is a continuation-in-part of U.S. application Ser. No. 09/707,277 filed Nov. 6, 2000 which is a continuation-in-part of U.S. application Ser. No. 09/183,004 filed Oct. 30, 1998 issued as U.S. Pat. No. 6,186,337 on Feb. 13, 2001—all of which applications and patents are incorporated herein in their entirety for all purposes and with respect to all of which the present invention claims priority under the Patent Laws.

### BACKGROUND OF THE INVENTION

1. Field of the Invention

The present invention is directed to glued screens for vibratory separator apparatuses and shale shakers; to methods for making such screens; and to vibratory separator apparatuses and shale shakers with such screens.

2. Description of Related Art

The prior art discloses a wide variety of vibrating screens, devices which use them, shale shakers, and screens for shale shakers. The screens catch, filter, or remove solids from fluid to be treated by a vibratory separator or shale shaker.

Certain prior art screens and screen assemblies for vibratory separators and shale shakers have areas of screening material which are undesirably non-flat and/or improperly tensioned, including but not limited to, screen assemblies with areas of screen material surrounded by cured epoxy. With certain such screens, these areas of screening material are often rippled, or wavy, i.e., not flat and not, therefore, properly tensioned or not optimally tensioned. A variety of problems and disadvantages are associated with such screens that have areas of rippled screening material: e.g., poor conveyance of solids across a screen; reduced screen life; and increased screen cost.

### SUMMARY OF THE PRESENT INVENTION

The present invention discloses, in at least certain aspects, methods for flattening certain non-flat areas of screening material on screen assemblies for vibratory separators and shale shakers, the methods including applying heated moisture-curing hot melt glue in a glue pattern to combine layers of screening material useful for screening fluid introduced to a vibratory separator or shale shaker. Following curing of the glue, there are non-flat portions of screening material between cured lines, portions or beads of the glue. The glued-together layers are then secured (welded, glued, or epoxied) to a tubular frame. Following curing of the epoxy (with the non-flat areas remaining between the cured glue lines), the resulting screen assembly is subjected to vibration while an aqueous fluid such as water, water with sand (or other solids), or drilling fluid with drilled cutting therein—all at a temperature at least higher than the ambient temperature around the vibratory device (separator or shaker) is introduced onto the screening assembly. Following such vibration and flowing of fluid, the non-flat portions of the screening material are flattened out. The screen assembly can then be removed from the separator for later use or it can then remain in use on the vibratory device for a desired time period.

The present invention discloses, in certain aspects, a screen assembly with a tubular frame having four tubular frame sides in a generally rectangular configuration with one crossmember or a plurality of spaced-apart crossmembers extending between the peripheral tubular frame sides. For effective emplacement of such a screen assembly on a shale shaker whose bed or deck has an upstanding member projecting above the bed or deck (e.g. a commercially available Cobra shale shaker), one or more (as required) of the crossmembers is notched or recessed to accommodate the upstanding member so that the screen assembly can lay flat on the bed or deck. The upstanding member projects into the notch, notches, recess, or recesses rather than abutting an unnotched, unrecessed part of the tubular crossmember and thereby preventing the screen assembly from laying flat on the deck or bed.

The present invention discloses, in at least certain embodiments, methods for flattening and/or tightening non-flat parts of glued together screening material combinations and such glued together screening material combinations, and screen assemblies with such a combination mounted on a tubular frame and secured thereto.

The present invention, in certain aspects, discloses a screen assembly with layers glued together by, e.g., heated (then cured) moisture-curing hot melt glue, and methods for producing such glued screen assemblies.

The present invention, in one embodiment includes a shale shaker with a frame; a “basket” or screen mounting apparatus; one or more screen assemblies according to the present invention as described above and below; and basket vibrating apparatus.

The present invention discloses, in certain aspects, a screen made by methods for making screens according to the present invention and screen assemblies as disclosed herein for a vibratory separator.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide:

New, useful, unique, efficient, non-obvious methods for flattening and/or tightening non-flat screening material on a screen assembly; screens with such screening material; and methods for using such screens; and

A shale shaker or vibratory separator with one or more such screens or screen assemblies.

Certain embodiments of this invention are not limited to any particular individual feature disclosed here, but include combinations of them distinguished from the prior art with their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a basis or creative impetus for designing other structures, methods and systems for carrying out and practicing the present invention. The claims of this invention should be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### BRIEF DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIGS. 1A and 1B are cross-section views of a screen assembly according to the present invention.

FIGS. 2A is a top view of a frame for a screening assembly according to the present invention.

FIG. 2B is a top view of screening material for a screen according to the present invention.

FIG. 2C is a top view of a screen assembly according to the present invention with a frame as in FIG. 2A and screening material as in FIG. 2B.

FIG. 3 is a cross-section view of a glue bead for screening material combinations according to the present invention.

FIG. 4A is a top view of a screen assembly according to the present invention.

FIG. 4B is a bottom view of the screen assembly of FIG. 4A.

FIG. 4C is an end view of one end of the screen assembly of FIG. 4A (and the opposing end is identical to that of FIG. 4C).

FIG. 4D is a side view of one side of the screen assembly of FIG. 4A (and the opposing side is identical to that of FIG. 4C).

FIG. 4E is a partial bottom perspective view of the screen assembly of 4A.

FIG. 4F is a partial bottom view of the screen assembly of FIG. 4A.

### DESCRIPTION OF EMBODIMENTS PREFERRED AT THE TIME OF FILING FOR THIS PATENT

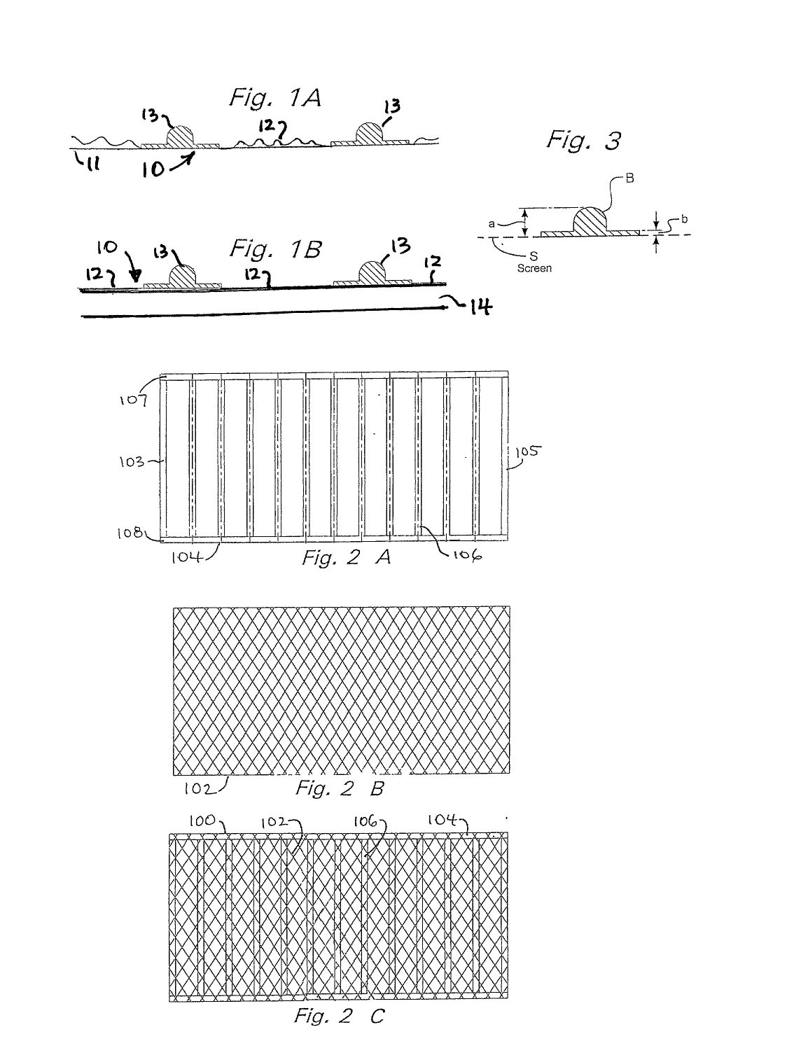

FIG. 1A shows a glued-together screen combination 10 with lower coarse mesh 11 and upper fine mesh or meshes 12. Following the gluing operation and curing of the glue 131, portions of the upper mesh or meshes are rippled, wavy, or non-flat (as shown). Following securing (e.g., by welding, by gluing, or by epoxying) of such a screen combination 10 to a tubular frame and then subjecting the resulting screen assembly to vibration on a vibratory shaker while fluid at a temperature above ambient temperature (e.g. at least five to twenty degrees hotter than ambient and including, but not limited to drilling fluids from a wellbore with a temperature up to a temperature of drilling fluid exiting a wellbore with drilled cuttings therein, e.g., in some case up to 160° F. or higher) is fed to the screen assembly, the non-flat portions of the screening material tighten and flatten, as shown in FIG. 1B.

FIG. 3 shows a cross-section or one glue bead's B profile applied to a screen S. The distance “a” is, in this embodiment, about one-sixteenth of an inch but may be any desired height as applied. Preferably the distance “b” is as thin as possible. Alternatively, the raised portion of glue (all above the level “b”) is deleted.

FIG. 2C shows a screen assembly 100 according to the present invention which has screening material 102 (FIG. 2B) secured onto a tubular frame 104 (FIG. 2A). In other aspects the frame 104 is deleted and a hookstrip is connected to each of two spaced-apart sides of the screening material 102. The screening material is any multi-layer screen according to the present invention with two, three or more layers glued together as referred to or as described herein with moisture curing hot melt glue according to the present invention. The multiple layers of glued together screening material 102 and the tubular frame 104 are encapsulated with a powdered epoxy in a semi-cured state and then the semi-cured powdered epoxy is heated, bonding the screening material to the frame 104. Following cooling, the cured powdered epoxy encapsulates the screen material forming a unitary structure.

The tubular frame 104 has a plurality of crossmembers 106 that extend between and whose ends are connected to sides 107, 108 of the frame 104. End members 103, 105 are at the ends of the frame 104. In certain aspects there are nine crossmembers 106. The tubular frame 104 and its parts may be made of hollow or solids beams, tubes, bars, or rods of metal (e.g. steel, aluminum, zinc, stainless steel and/or alloys of any of these), plastic, or fiberglass. Metal and/or plastic parts may be welded together.

In one particular aspect the frame 104 is made of hollow square cross-section tubes 103, 104, 107, 108 with a 0.766 inch square cross-section and round cross-section tubes 106 with a 0.601 square inch cross-section. The screen assembly 100 (and the frame 104) may have any suitable desired length and width. In one aspect the screening material is made of strands of 304, or 316 stainless steel and the frame is made of carbon steel. In another aspect the crossmembers 106 and/or end members 103, 105 are made of tubular members with a circular, oval, or elliptical cross-section. Any crossmember or multiple crossmembers may have one, two, or more notches as described below.

In one aspect the screening material is secured to the frame with a powdered epoxy material. The frame is heated then dipped into a fluidized bed of the powder which completely encapsulates the frame in a semi-cured state and, in one particular aspect, with a thickness of about 35 mils. The frame and screening material are put on a heated platen with the screening material (in one case three layers 170×105 mesh, 105×64 mesh and 19 mesh glued together with a method according to the present invention) below the frame. Upon heating to about 450 degrees F., the powdered epoxy material is heated and flows down over the wires of the screening material. In one aspect the wires are partially coated and in another they are, preferably, completely encapsulated with the adhesive. The frame with the screening material on it is left on the heated platen until the coating is cured, being heated when it is curing. In one aspect the coating encapsulates the frame. Any glue bead pattern and application method described in the parent patent applications of this invention may be used according to the present invention.

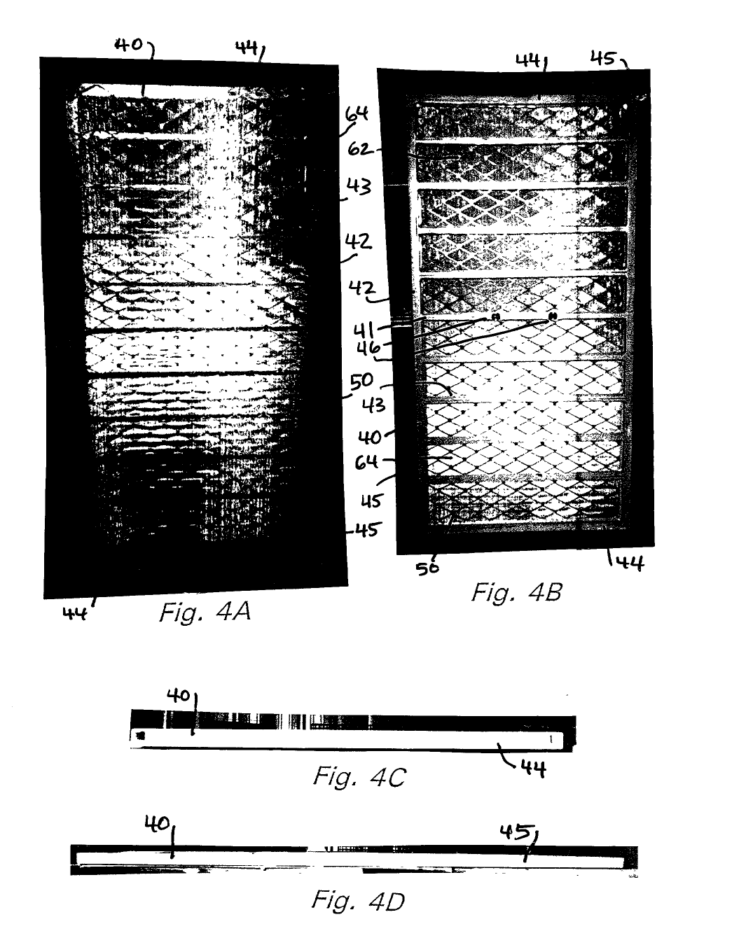

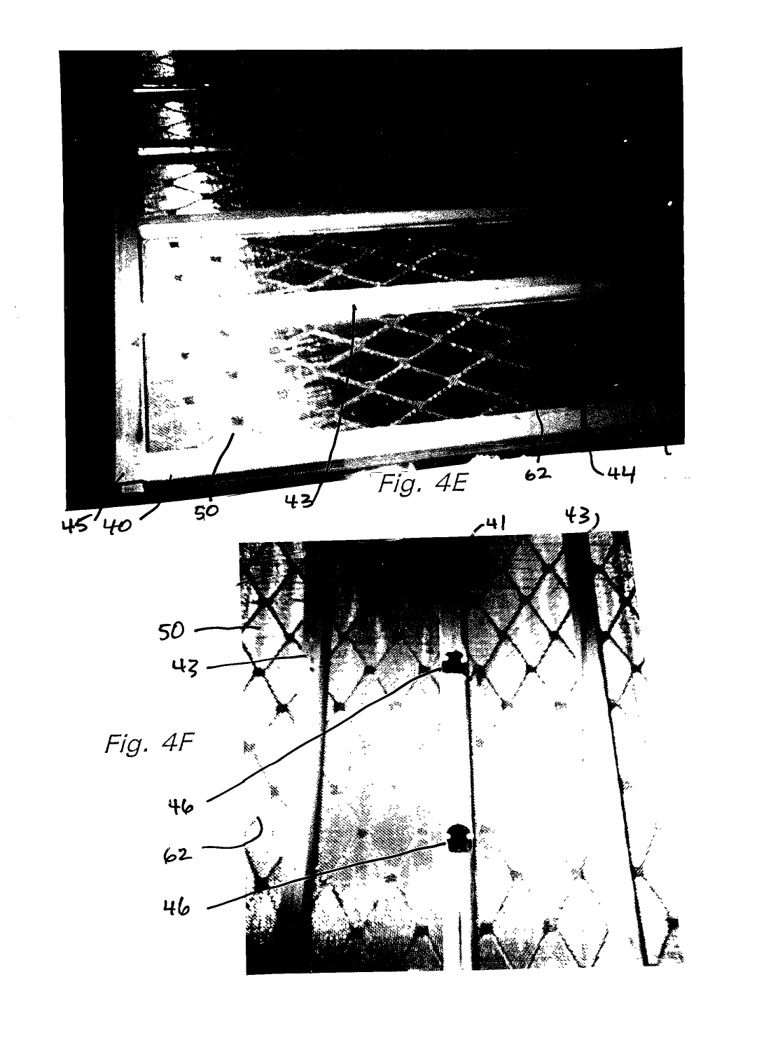

FIGS. 4A-4F show a screen assembly 40 according to the present invention which has a tubular frame 42 with ends 44 and interconnected sides 45. A screening material combination 50 is secured with cured epoxy to the tubular frame 42. A crossmember 41 (of a plurality of spaced-apart crossmembers 43 that extend between and have ends connected to the sides 45) has two notches 46, either of which is for receiving a portion of an upstanding member of a shale shaker deck.

In certain shale shakers in which screen assemblies without crossmembers such as the crossmember 41 are used, one or more upstanding members are located so that they do not push up on a screen assembly above them and such upstanding members are often used for proper screen assembly positioning, for preventing unwanted screen movement with respect to a shaker deck, or for stabilizing screen assemblies in position. Rather than removing such upstanding member(s) when a screen assembly is used that does have one or more crossmembers that would undesirably abut the top of an upstanding member (preventing correct screen assembly emplacement on a deck), a screen assembly according to the present invention may be installed on such a shaker deck so that a portion of the upstanding member (which is perpendicular to the crossmember 41 as viewed from above or below) is received in and projects into one (or more) of the notches 46. With a screen assembly 40 as shown, the crossmembers 43 on either side of the crossmember 41 are sufficiently spaced-apart from the crossmember 41 that the upstanding member does not contact the adjacent crossmembers 43. Although only one notch 46 can accommodate an upstanding member, by using two notches 46, proper emplacement of the screen assembly 40 over the upstanding member is made “fool proof”—i.e. whichever side of the screen assembly is placed nearest the shaker's exit end (or fluid introduction end) one of the notches will be above the upstanding member. Of course it is within the scope of the present invention to place aligned notches on adjacent crossmembers to accommodate an upstanding member of such dimensions that it extends beyond the distance separating two, three, four or more crossmembers.

The screen assembly 40 as shown has a multi-layer combination 50 of layers of screening material glued together with moisture curing hot melt glue in a glue pattern 62. The multi-layer glued-together combination 60 is secured to the tubular frame 42 with cured epoxy. As shown the screen assembly 40 has not yet been vibrated with fluid flowing onto it and areas 64 of screening material between glue lines are non-flat or rippled (as shown). Subjecting the screen assembly 40 to vibration and fluid flow according to the present invention will result, according to the present invention, in the flattening of the non-flat screening material in the areas 64.

It is within the scope of the present invention to provide a screen assembly with a support for a glued-together combination of multiple layers of screening material (e.g. any glued-together multi-layer combination disclosed herein or in parent patent applications of this invention). In one respect such a support has a perforated plate (instead of the tubular frame, e.g. instead of the tubular frame 14, FIG. 1B; the tubular frame 42, FIG. 4A; or the tubular frame 104, FIG. 2A). Any suitable known perforated plate may be used. Such a screen assembly with a perforated plate is within the scope of the present invention with or without non-flat screening areas; and such a screen assembly may have spaced-apart side hookstrips for mounting in a shale shaker.

Flattening and/or tightening of non-flat screening areas (e.g. as in the screen assemblies of FIGS. 1A, 2A and 4A) may, according to the present invention, be facilitated by flowing fluid at a temperature above ambient temperature onto the screen assemblies. In certain aspects the fluid temperature is between five degrees to twenty degrees above ambient temperature. Such a temperature may be achieved using any known heater apparatus and/or by pumping fluid, e.g., but not limited to, pumping fluid with the typical known fluid pumping apparatus associated with known shale shakers. In other aspects, when the fluid pumped onto the screen assemblies is drilling fluid from a wellbore being drilled, the drilling fluid having drilled cuttings, etc. therein, the fluid temperature may be between 100° F. and 160° F. or higher.

In one particular embodiment a screen assembly as in FIG. 4A was run on two commercially available King Cobra shale shakers for a total of about 96 hours with 16 pound oil-based drilling fluid with drilled cuttings and shale solids therein being treated by the screen assembly. Following this use the screening material areas which were non-flat were flattened and tightened. In another embodiment, a screen assembly as in FIG. 4A was run on a King Cobra shaker for 120 hours and fluid slightly above ambient temperature (e.g. four to twelve degrees F. above ambient) was fed to the screen assembly, the fluid weighing about nine pounds per gallon and containing sand, water, and bentonite (by weight, about 92% water, 4% sand and 4% bentonite). Following this use screening material areas that were non-flat were flattened and tightened.

It is within the scope of this invention to flatten non-flat screening material areas between glue lines of a multi-layer screening material combination of a screen assembly by vibrating the screen assembly for a sufficient time period on a shale shaker while feeding fluid thereto at a sufficiently high temperature to effect flattening and/or tightening of the non-flat areas. Such fluid may or may not contain drilled cuttings, sand, and/or other solids.

The present invention, therefore, in at least certain embodiments, provides methods for flattening non-flat areas of screening material of a screen assembly, the non-flat areas of screening material between lines of glue gluing together a plurality of layers of screening material, the plurality of glued-together layers of screening material secured to a frame, the methods including mounting the screen assembly on a vibratory separator (e.g., but not limited to a shale shaker), the vibratory separator located in an environment at an ambient temperature, vibrating the screen assembly with the vibratory separator for a period of time, feeding material to be treated onto the screen assembly, the material to be treated at a material temperature above the ambient temperature, the period of time of such a temporal length and the material temperature of such a temperature to effect flattening of the non-flat areas of screening material. Such methods may include one or some (in any possible combination) of the following: wherein the material temperature is at least five degrees above the ambient temperature; wherein the material temperature is at least 100° F.; wherein the material is water with sand therein or drilling fluid from a drilled wellbore, the drilling fluid having solid drilled cuttings therein; wherein the glue is cured moisture-curing hot melt glue; wherein the glue is applied in a pattern; wherein the frame is comprised of two ends, each end connected to and spaced-apart by one of two spaced-apart sides; wherein the ends and sides are tubular members; wherein the two spaced-apart sides include a first side and a second side and the frame includes a plurality of spaced-apart crossmembers, each crossmember extending from the first side to the second side; wherein the glued-together layers of screening material are secured to the frame with epoxy; wherein the glued-together layers of screening material are secured to the frame with glue; wherein the glued-together layers of screening material are secured to the spaced-apart crossmembers by welding, with epoxy or with glue; wherein at least one of the plurality of spaced-apart crossmembers has at least one notch or multiple notches for receiving a portion of an upstanding member of a deck of the vibratory separator, the method including installing the screen assembly on the deck of the vibratory separator with a portion of the upstanding member projecting into the at least one notch or in one of the notches; wherein the plurality of layers of screening material are at least a lower layer of coarse mesh and at least one layer of fine mesh or a lower layer of coarse mesh and two or three layers of finer mesh above the layer of coarse mesh; wherein the non-flat areas of screening material are portions of the at least one layer of fine mesh.

The present invention, therefore, in at least certain embodiments, provides methods for mounting a screen assembly on a deck of a vibratory separator, the deck having one or more upstanding members projecting above the deck, the screen assembly having a frame with at least one crossmember, the frame supporting screening material, the at least one crossmember having a notch therein for receiving a portion of an upstanding member, the method including emplacing the screen assembly on the deck with a portion of an upstanding member in the notch.

The present invention, therefore, in at least certain embodiments, provides a screen assembly for a vibratory separator, the vibratory separator having a deck for supporting the screen assembly, the deck having an upstanding member with a portion projecting above the deck, the screen assembly having a frame, screening material secured to the frame, the screening material having at least one layer of screen mesh, the at least one layer of screen mesh connected to the frame, the frame having at least one crossmember, the at least one crossmember having at least one notch therein, and a portion of the upstanding member of the deck receivable in the notch. Such a screen assembly may have the at least one layer of screening mesh including a plurality of layers of screen mesh glued together; and/or the at least one notch being is two (or more) spaced-apart notches, each notch positioned so that one of the notches can receive the portion of the upstanding member when the screen assembly is emplaced on the deck; and/or multiple crossmembers of the frame may each have one, two, or more notches for receiving a portion of a deck's upstanding member(s).

In conclusion, therefore, it is seen that the present invention and the embodiments disclosed herein and those covered by the appended claims are well adapted to carry out the objectives and obtain the ends set forth. Certain changes can be made in the subject matter described, shown and claimed without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form its principles may be utilized.

What is claimed is:

1. A method for flattening non-flat areas of screening material of a screen assembly, the non-flat areas of screening material between lines of glue gluing together a plurality of layers of screening material, the plurality of glued-together layers of screening material secured to a frame, the method comprising
mounting the screen assembly on a vibratory separator, the vibratory separator located in an environment at an ambient temperature,
vibrating the screen assembly with the vibratory separator for a period of time,
feeding material to be treated onto the screen assembly, the material to be treated at a material temperature above the ambient temperature,
the period of time of such a temporal length and the material temperature of such a temperature to effect flattening of the non-flat areas of screening material.

2. The method of claim 1 wherein the material temperature is at least five degrees above the ambient temperature.

3. The method of claim 1 wherein the material temperature is at least 100° F.

4. The method of claim 1 wherein the material is drilling fluid from a drilled wellbore, the drilling fluid having solid drilled cuttings therein.

5. The method of claim 1 wherein the glue is cured moisture-curing hot melt glue.

6. The method of claim 1 wherein the glue is applied in a pattern.

7. The method of claim 1 wherein the frame is comprised of two ends, each end connected to and spaced-apart by one of two spaced-apart sides.

8. The method of claim 7 wherein the ends and sides are tubular members.

9. The method of claim 7 wherein the two spaced-apart sides include a first side and a second side and the frame includes a plurality of spaced-apart crossmembers, each crossmember extending from the first side to the second side.

10. The method of claim 1 wherein the glued-together layers of screening material are secured to the frame with epoxy.

11. The method of claim 1 wherein the glued-together layers of screening material are secured to the frame with glue.

12. The method of claim 9 wherein the glued-together layers of screening material are secured to the spaced-apart crossmembers with epoxy.

13. The method of claim 9 wherein the glued-together layers of screening material are secured to the spaced-apart crossmembers with glue.

14. The method of claim 9 wherein at least one of the plurality of spaced-apart crossmembers has at least one notch for receiving a portion of an upstanding member of a deck of the vibratory separator, the method further comprising
installing the screen assembly on the deck of the vibratory separator with a portion of the upstanding member projecting into the at least one notch.

15. The method of claim 1 wherein the plurality of layers of screening material comprises at least a lower layer of coarse mesh and at least one layer of fine mesh.

16. The method of claim 15 wherein the non-flat areas of screening material comprise portions of the at least one layer of fine mesh.

17. A method for mounting a screen assembly on a deck of a vibratory separator, the deck having an upstanding member projecting above the deck, the screen assembly having a frame with at least one crossmember, the frame supporting screening material, the at least one crossmember having a notch therein for receiving a portion of the upstanding member, the method comprising
emplacing the screen assembly on the deck with a portion of the upstanding member in the notch.

18. A screen assembly for a vibratory separator, the vibratory separator having a deck for supporting the screen assembly, the deck having an upstanding member with a portion projecting above the deck, the screen assembly comprising
a frame,
screening material secured to the frame, the screening material comprising at least one layer of screen mesh, the at least one layer of screen mesh connected to the frame,
the frame having at least one crossmember,
the at least one crossmember having at least one notch therein, and
a portion of the upstanding member of the deck receivable in the notch.

19. The screen assembly of claim 18 wherein the at least one layer of screening mesh comprising
a plurality of layers of screen mesh glued together.

20. The screen assembly of claim 18 wherein the at least one notch is two spaced-apart notches, each notch positioned so that one of the two notches can receive the portion of the upstanding member when the screen assembly is emplaced on the deck.

21. Any invention disclosed herein.
